(19) United States
(12) Patent Application Publication
(10) Pub. No.: US 2020/0394402 A1
(43) Pub. Date: Dec. 17, 2020

(54) OBJECT IDENTIFICATION DEVICE, OBJECT IDENTIFICATION SYSTEM, OBJECT IDENTIFICATION METHOD, AND PROGRAM RECORDING MEDIUM

(71) Applicant: NEC Corporation, Minato-ku, Tokyo (JP)

(72) Inventor: Takeharu KITAGAWA, Tokyo (JP)

(73) Assignee: NEC Corporation, Minato-ku, Tokyo (JP)

(21) Appl. No.: 16/975,216

(22) PCT Filed: Mar. 7, 2019
(86) PCT No.: PCT/JP2019/008990

§ 371 Date: Aug. 24, 2020

(30) Foreign Application Priority Data
Mar. 9, 2018 (JP) 2018-043237

(51) Int. Cl. G06K 9/00; G06K 9/62; G06T 7/70; G06T 7/60

(52) U.S. Cl. CPC G06K 9/00624; G06K 9/6201; G06T 2207/20021; G06T 7/60; G06T 7/70

(57) ABSTRACT

An object identification device includes an acquisition unit and an identification unit. With respect to an object detected in each of a plurality of images captured from positions spaced apart from each other, the acquisition unit acquires at least one of the three types of information, which are: information about an inclination of a reference line of the object with respect to a reference line of a captured image; information related to the size of the object in a captured image; and information related to the disposed position of the object in a captured image. The identification unit compares sets of information acquired from respective captured images, and determines that, when the difference between the compared sets of information falls within a preset allowable range, objects captured in the respective images are the same.

### TECHNICAL FIELD

The present invention relates to a technology for specifying the same object from a plurality of captured images that are captured from positions located side by side with an interval interposed therebetween.

### BACKGROUND ART

As a camera capable of acquiring information in a depth direction from captured images, a stereo camera is available. As an example of a configuration of a stereo camera, there is a configuration in which two lenses being placed side by side with each other cause binocular disparity to be achieved, and using captured images captured through the lenses enables information in the depth direction relating to a subject to be acquired.

PTLs 1 to 3 describes technologies for recognizing the same object from a plurality of captured images. Specifically, PTL 1 describes a technology of detecting an object (fish) to be tracked from captured images of an inside of an aquarium that are captured from an upper side and a side of the aquarium at the same time, and determining, by use of an epipolar line passing through the centroid position of the detected object (fish), that detected objects in the captured images are the same individual.

PTL 2 describes a technology of specifying a moving object that is the same as a moving object captured in one of two videos the image capturing angles of which are substantially different, from a plurality of moving objects captured in the other of the two videos. In PTL 2, a moving object to be specified is specified based on characteristics of a silhouette moving object region of the moving object to be specified, dynamic characteristics of moving objects in the videos, and degrees of similarity among moving objects determined with these characteristics taken into consideration.

PTL 3 describes a technology of acquiring n measurement images chronologically and track the same fish captured in the n measurement images.

### CITATION LIST

### Patent Literature

[PTL 1] Japanese Unexamined Patent Application Publication No. 2003-250382

[PTL 2] Japanese Unexamined Patent Application Publication No. 2010-244440

[PTL 3] Japanese Unexamined Patent Application Publication No. 2016-165238

### SUMMARY OF INVENTION

### Technical Problem

There are some cases where, by placing a plurality of image capturing devices side by side with an interval interposed therebetween, the image capturing devices are made to function as a stereo camera. In this case, in order to acquire information in the depth direction (a direction away from the image capturing devices) relating to a subject, it is required to specify the same subject in captured images that are captured by the image capturing devices at the same time.

However, when cultivated fish is captured by such image capturing devices that are made to function as a stereo camera in a fish preserve in which cultivation of fish is performed, a problem occurs that it is difficult to specify the same subject in captured images captured by the image capturing devices. Specifically, since a large number of fishes swim in the fish preserve and, in a case of cultivation, the fishes are of the same type and have approximately the same sizes, it is difficult to perform individual identification. In addition, when the plurality of image capturing devices to be made to function as a stereo camera are arranged with an interval of, for example, approximately 1 meter interposed therebetween, even the same fish captured in captured images of vicinities of the image capturing devices sometimes has different appearances or different positional relationships with fishes in the surroundings. There is a problem that, because of such circumstances, it is difficult to specify the same fish captured in a plurality of captured images.

The present invention has been made in order to solve the above-described problems. Specifically, a principal object of the present invention is to provide a technology of increasing reliability of processing of specifying the same object from a plurality of captured images that are captured from positions located side by side with an interval interposed therebetween.

### Solution to Problem

In order to achieve the above-described object, an object identification device according to the present invention includes:

an acquisition unit that acquires, with respect to objects each of which is detected in one of a plurality of captured images that are captured from positions located side by side with an interval interposed between the positions, at least one piece of information among information on an inclination of a baseline of the object with respect to a baseline of the captured image, information related to a size of the object in the captured image, and information related to an arrangement position of the object in the captured image; and

an identification unit that compares pieces of information each of which is acquired from one of the captured images by the acquisition unit and determines that the objects in the captured images a difference of which in compared pieces of information falls within a preset allowable range are the same object.

An object identification system according to the present invention includes:

an image capturing device that captures an image of an object to be detected from positions located side by side with an interval interposed between the positions; and

an object identification device that determines whether objects in a plurality of captured images that are captured by the image capturing device are the same object, in which

the object identification device includes:

an acquisition unit that acquires, with respect to objects each of which is detected in one of a plurality of the captured images, at least one piece of information among information on an inclination of a baseline of the object with respect to a baseline of the captured image, information related to a size of the object in the captured image, and information related to an arrangement position of the object in the captured image; and

an identification unit that compares pieces of information each of which is acquired from one of the captured images by the acquisition unit and determines that the objects in the captured images a difference of which in compared pieces of information falls within a preset allowable range are the same object.

Further, an object identification method according to the present invention includes:

acquiring, with respect to objects each of which is detected in one of a plurality of captured images that are captured from positions located side by side with an interval interposed between the positions, at least one piece of information among information on an inclination of a baseline of the object with respect to a baseline of the captured image, information related to a size of the object in the captured image, and information related to an arrangement position of the object in the captured image;

comparing pieces of information each of which is acquired from one of the captured images; and

determining that the objects in the captured images a difference of which in compared pieces of information falls within a preset allowable range are the same object.

Still further, a program recording medium according to the present invention records a computer program causing a computer to perform:

acquiring, with respect to objects each of which is detected in one of a plurality of captured images that are captured from positions located side by side with an interval interposed between the positions, at least one piece of information among information on an inclination of a baseline of the object with respect to a baseline of the captured image, information related to a size of the object in the captured image, and information related to an arrangement position of the object in the captured image;

comparing pieces of information each of which is acquired from one of the captured images; and

determining that the objects in the captured images a difference of which in compared pieces of information falls within a preset allowable range are the same object.

### Advantageous Effects of Invention

The present invention enables reliability of processing of specifying the same object from a plurality of captured images that are captured from positions located side by side with an interval interposed therebetween.

### BRIEF DESCRIPTION OF DRAWINGS

FIG. 1 is a block diagram illustrating a configuration of an information processing device of a first example embodiment according to the present invention, the information processing device including functions of an object identification device, in a simplified manner.

FIG. 2A is a diagram describing a configuration of an image capturing device providing the information processing device in the first example embodiment with captured images;

FIG. 2B is a perspective view illustrating the image capturing device providing the information processing device in the first example embodiment with captured images;

FIG. 3 is a diagram describing a mode in which the image capturing device captures images of fishes that are objects to be detected in the first example embodiment;

FIG. 4 is a diagram describing an example of a form in which captured images are displayed on a display device in the first example embodiment;

FIG. 5 is a diagram describing an example of objects (fish bodies) that are not detected in the first example embodiment;

FIG. 6 is a diagram illustrating an example of a detection region (fish body detection region) including detected objects (fish bodies) in the captured image in the first example embodiment;

FIG. 7 is a diagram describing inclination θ of an object (fish body) detected in the captured image in the first example embodiment;

FIG. 8 is a diagram describing information related to arrangement positions of objects acquired from the captured images in the first example embodiment;

FIG. 9 is a diagram describing information related to sizes of objects acquired from the captured images in the first example embodiment;

FIG. 10 is a diagram describing an example of processing of calculating, by use of an identified fish body, a body depth of the fish body;

FIG. 11 is a block diagram illustrating a configuration of an object identification device of another example embodiment according to the present invention; and

FIG. 12 is a block diagram illustrating a configuration of an object identification system including the object identification device illustrated in FIG. 11.

### EXAMPLE EMBODIMENT

Example embodiments according to the present invention will be described below with reference to the drawings.

### First Example Embodiment

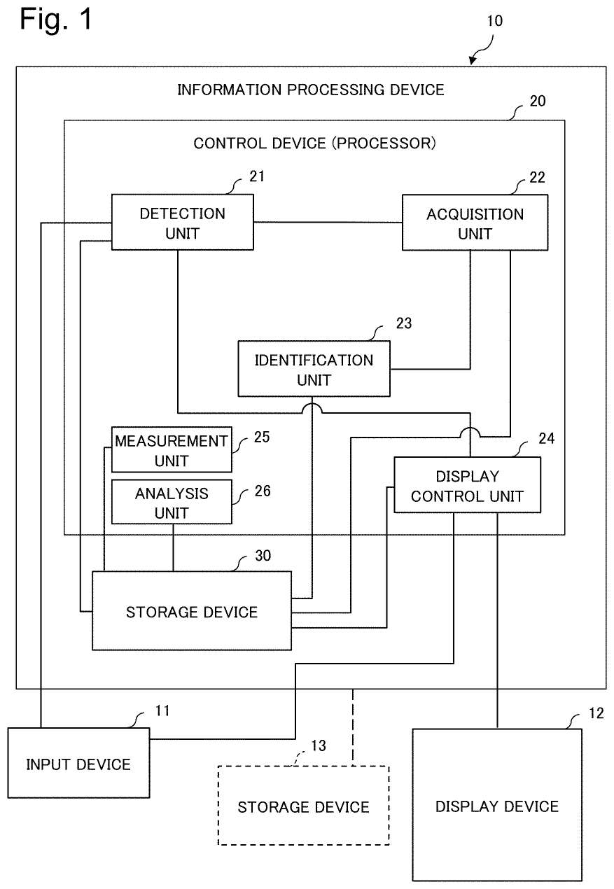

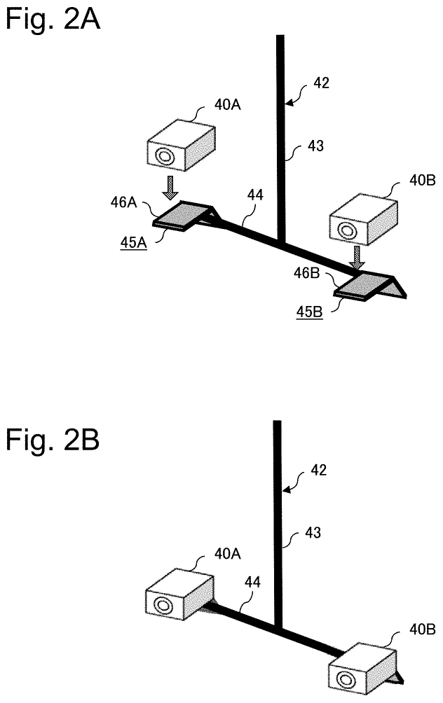

FIG. 1 is a block diagram illustrating a configuration of an information processing device of a first example embodiment according to the present invention, the information processing device having a function as an object identification device, in a simplified manner. The information processing device 10 in the first example embodiment has a function relating to processing of detecting (calculating) the length and the like of an object to be measured from captured images in which the object to be measured is captured. The information processing device 10 has a function of detecting (identifying) the same object in a plurality of captured images that were captured by a plurality of (two) cameras 40A and 40B as illustrated in FIG. 2A at the same time. The information processing device 10 constitutes, in conjunction with the cameras 40A and 40B, a measurement system (object identification system) including an object identification function.

Although, in the first example embodiment, the cameras 40A and 40B are image capturing devices having a function of capturing a video, image capturing device that, instead of having a video capturing function, for example, intermittently captures still images at each preset time interval may be employed as the cameras 40A and 40B.

Herein, the cameras 40A and 40B capture images of subjects while being placed side by side with an interval interposed therebetween, as illustrated in FIG. 2B, by being supported by and fixed to a support member 42 as illustrated in FIG. 2A. The support member 42 is constituted including an extensible rod 43, an attachment rod 44, and attachment fixtures 45A and 45B. In this example, the extensible rod 43 is a freely extensible and retractable rod member and further includes a structure that enables the length thereof to be fixed at a length appropriate for use within a length range in which the extensible rod 43 is extensible and retractable. The attachment rod 44 is made of a metallic material, such as aluminum, and is joined to the extensible rod 43 in such a way as to be orthogonal to the extensible rod 43. To the attachment rod 44, the attachment fixtures 45A and 45B are fixed at sites that are symmetrically located with respect to the joint portion with the extensible rod 43. The attachment fixtures 45A and 45B include mounting surfaces 46A and 46B and have a structure that enables the cameras 40A and 40B mounted on the mounting surfaces 46A and 46B to be fixed to the mounting surfaces 46A and 46B by means of, for example, screws without backlash, respectively.

The cameras 40A and 40B are capable of maintaining a state of being placed side by side with a preset interval interposed therebetween by being fixed to the support member 42 having a structure as described above. In the first example embodiment, the cameras 40A and 40B are fixed to the support member 42 in such a way that lenses disposed to the cameras 40A and 40B face the same direction and the optical axes of the lenses are set to be parallel with each other. The support member supporting and fixing the cameras 40A and 40B is not limited to the support member 42 illustrated in FIG. 2A and the like. For example, the support member supporting and fixing the cameras 40A and 40B may have, in place of the extensible rod 43 in the support member 42, a structure in which one or a plurality of ropes are used and the attachment rod 44 and the attachment fixtures 45A and 45B are suspended by the ropes.

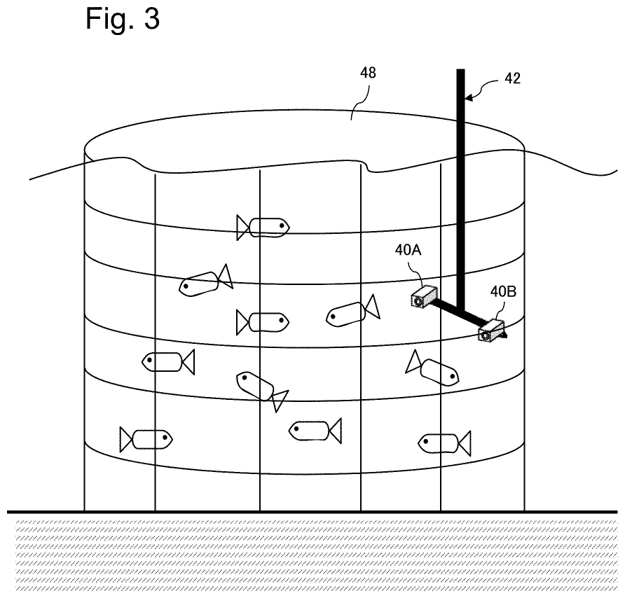

The cameras 40A and 40B, while being fixed to the support member 42, are, for example, made to enter a fish preserve 48 in which fishes are cultivated, as illustrated in FIG. 3 and arranged at a depth in the water and with a direction of the lenses that are determined to be appropriate for observation of fishes (in other words, image-capturing of fishes that are objects to be measured). As a method of arranging and fixing the support member 42 (the cameras 40A and 40B), which is made to enter the fish preserve 48, at an appropriate depth in the water and with an appropriate direction of the lenses, various methods are conceivable, and, herein, any method can be employed and a description of the method will be omitted. Calibration of the cameras 40A and 40B is performed using an appropriate calibration method that takes into consideration the environment of the fish preserve 48 and the types of fishes to be measured. A description of the calibration method will be omitted herein.

Further, as a method for starting image-capturing by the cameras 40A and 40B and stopping the image-capturing, an appropriate method selected in consideration of the performance of the cameras 40A and 40B, the environment of the fish preserve 48, and the like is employed. For example, an observer (measurer) of fishes manually starts image-capturing before making the cameras 40A and 40B enter the fish preserve 48 and manually stops the image-capturing after having made the cameras 40A and 40B leave the fish preserve 48. When the cameras 40A and 40B are equipped with the function of wireless communication or wired communication, an operation device that is capable of transmitting information for controlling image-capturing start and image-capturing stop is connected to the cameras 40A and 40B. The image-capturing start and the image-capturing stop may be controlled by the observer operating the operation device.

A monitor device that is capable of receiving images that either or both of the camera 40A and the camera 40B is/are capturing from the cameras 40A and 40B by means of wired communication or wireless communication may be used. In this case, the observer becomes able to see, through the monitor device, images being captured. This configuration, for example, enables the observer to change the image-capturing direction or the depth in the water of the cameras 40A and 40B while seeing images being captured. A mobile terminal provided with a monitoring function may be used as the monitor device.

The information processing device 10 uses, in the processing of calculating lengths (for example, fork length) of a fish, a captured image from the camera 40A and a captured image from the camera 40B that were captured at the same time. In consideration of this requirement, in order to facilitate acquiring an image captured by the camera 40A and an image captured by the camera 40B that were captured at the same time, it is preferable to make the cameras 40A and 40B, while capturing images, also capture changes that serve as marks to be used in time alignment. For example, it may be configured such that, as marks to be used in time alignment, light that is emitted for a short period of time by means of automatic control or manually by the observer is to be used and the cameras 40A and 40B capture the light. This configuration enables time alignment (synchronization) between an image captured by the camera 40A and an image captured by the camera 40B, based on the light captured in the images captured by the cameras 40A and 40B to be facilitated.

The above-described images captured by the cameras 40A and 40B may be taken into the information processing device 10 by means of wired communication or wireless communication or may, after having been stored in a portable storage medium (for example, a secure digital (SD) card), be taken into the information processing device 10.

The information processing device 10, when outlined, includes a control device 20 and a storage device 30, as illustrated in FIG. 1. The information processing device 10 is connected to an input device (for example, a keyboard, a mouse, or a touch panel) 11 for inputting information to the information processing device 10 through, for example, operation by the measurer and a display device 12 for displaying information. Further, the information processing device 10 may be connected to an external storage device 13, which is a separate entity from the information processing device 10.

The storage device 30 has a function of storing various types of data and computer programs (hereinafter, also referred to as programs) and is achieved by a storage medium, such as a hard disk device and a semiconductor memory. The number of storage devices with which the information processing device 10 is provided is not limited to one and the information processing device 10 may be provided with a plurality of types of storage devices, and, in this case, the plurality of storage devices are collectively referred to as storage devices 30. The storage device 13 also has, as with the storage device 30, a function of storing various types of data and computer programs and is achieved by a storage medium, such as a hard disk device and a semiconductor memory. When the information processing device 10 is connected to the storage device 13, appropriate information is stored in the storage device 13. Although, in this case, the information processing device 10 appropriately performs processing of writing and reading information to and from the storage device 13, a description about the storage device 13 will be omitted in the following description.

In the first example embodiment, images captured by the cameras 40A and 40B are stored in the storage device 30 in association with identification information for identifying a camera that captured each image and information on an image-capturing situation, such as information of a capture time.

The control device 20 is constituted by a processor, such as a central processing unit (CPU) and a graphics processing unit (GPU). The control device 20 is capable of having functions as follows by, for example, the processor executing computer programs stored in the storage device 30. That is, the control device 20 includes, as functional units, a detection unit 21, an acquisition unit 22, an identification unit 23, a display control unit 24, a measurement unit 25, and an analysis unit 26.

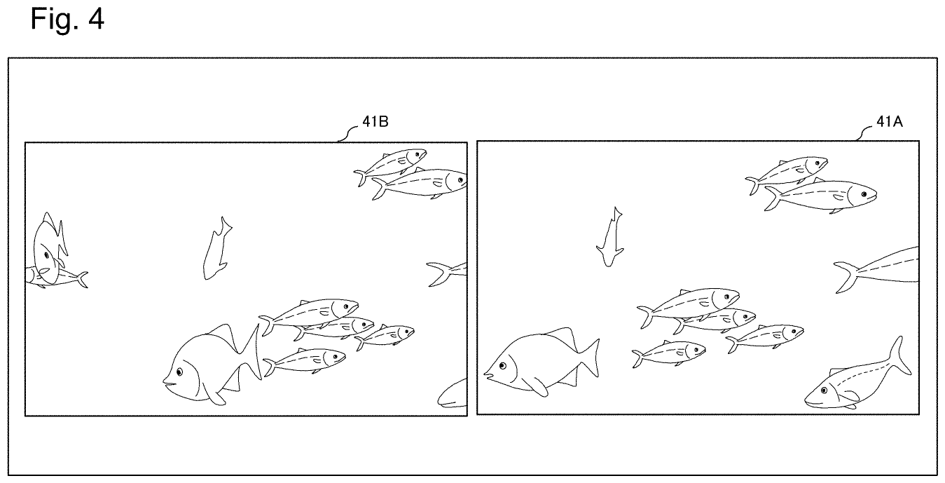

The display control unit 24 has a function of controlling display operation of the display device 12. For example, when the display control unit 24 receives, from the input device 11, a request to reproduce captured images captured by the cameras 40A and 40B, the display control unit 24 reads, from the storage device 30, the captured images captured by the cameras 40A and 40B in accordance with the request and displays the captured images on the display device 12. For example, by means of dual screen display as illustrated in FIG. 4, a captured image 41A captured by the camera 40A and a captured image 41B captured by the camera 40B are displayed side by side on the display device 12 by the display control unit 24.

The display control unit 24 has a function capable of synchronizing the captured images 41A and 41B with each other in such a way that the image-capturing time points of the captured images 41A and 41B, which are displayed on the display device 12 at the same time, coincide with each other. For example, the display control unit 24 has a function enabling the observer to adjust each pair of reproduced frames of the captured images 41A and 41B by use of marks for time alignment as described afore that were simultaneously captured by the cameras 40A and 40B.

The detection unit 21 has a function of detecting a fish to be measured and a function of detecting measurement-use points on the detected fish to be measured in the captured images 41A and 41B, which are displayed (reproduced) on the display device 12.

That is, the detection unit 21 detects a fish to be measured in the following way. For example, the detection unit 21 detects, in the captured images 41A and 41B displayed (reproduced) on the display device 12, a fish body to be measured by use of reference data for fish body detection, which are stored in the storage device 30. The detection processing by the detection unit 21 is performed in a pair of frames specified by the observer, in all pairs of frames during a preset period of time, or for every preset number of pairs of frames in the captured images 41A and 41B (video) displayed (reproduced) on the display device 12. The reference data for fish body detection is generated through, for example, machine learning. In the machine learning, fish bodies of a type to be measured are learned by use of, as training data, a large number of images of fish bodies with respect to the type of fish to be measured.

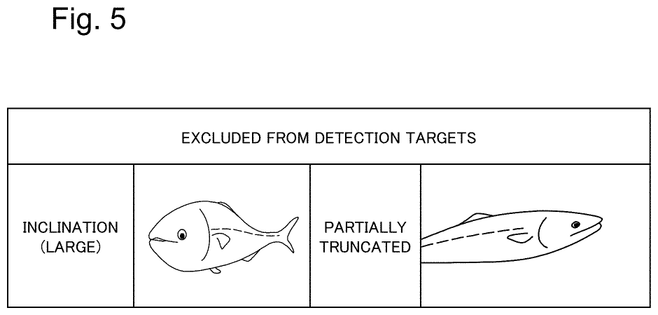

Herein, for example, an image of a fish the inclination of which is large and an image of a fish a portion of the body of which is not captured as illustrated in FIG. 5 are excluded from detection targets and are not learned as fish bodies to be measured. Since such images of fish bodies that were not learned as fish bodies are not reflected by the reference data for fish body detection, the detection unit 21 does not detect fish bodies as illustrated in FIG. 5 as a fish to be measured. There exist various methods of machine learning, and an appropriate method of machine learning is employed herein. Further, the number of fish bodies detected as fish bodies to be measured by the detection unit 21 in a captured image frame is not necessarily one, and there are some cases where a plurality of fish bodies are detected as fish bodies to be measured.

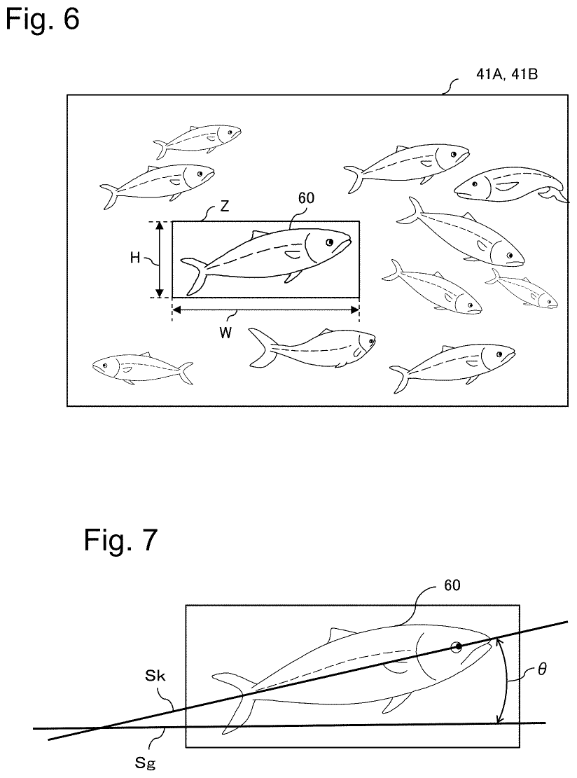

In the first example embodiment, the detection unit 21 also has a function of detecting an image area that clearly indicates a detected fish body as a detection region (hereinafter, also referred to as a fish body detection region) in the captured images 41A and 41B. The fish body detection region is an image area having a preset shape that extracts a detected fish in a distinguishable manner from other fish bodies, and the size of the fish body detection region varies according to the size of a detected fish. For example, as illustrated in FIG. 6, the detection unit 21 detects, in the captured images 41A and 41B, a rectangular fish body detection region Z extracting a fish body (hereinafter, also referred to as a detected fish body) 60 that was detected, in a distinguishable manner from other fish bodies. When, in a captured image frame, a plurality of fish bodies were detected as fish bodies to be measured by the detection unit 21, a fish body detection region Z is detected with respect to each of the detected fish bodies 60. The detection unit 21 may have a function of making the display control unit 24 display the detected fish body detection regions Z in the captured images 41A and 41B.

The detection unit 21 still further has a function of detecting points used for measurement (hereinafter, also referred to as measurement-use points) on a fish body 60 detected as a measurement target in the captured images 41A and 41B. Herein, a bifurcating portion of the tail and the mouth of a fish are detected as measurement-use points. While the detection method of the measurement-use points is not limited to a specific method and the measurement-use points are detected by use of an appropriate method selected in consideration of needs of the measurer and the performance of the control device, an example of the detection method will be described below.

For example, the detection unit 21 detects the measurement-use points, based on reference data for detection of measurement-use points that are generated through machine learning. The reference data for detection of measurement-use points are generated through machine learning using, as training data, image data of whole fish bodies provided with measurement-use points and are stored in the storage device 30. Alternatively, the reference data for detection of measurement-use points may be, instead of reference data of whole fish bodies, reference data of each fish body part. Herein, the reference data of each fish body part are generated through machine learning using, as training data, image data of mouth portions of fishes provided with measurement-use points and image data of tail portions of fishes provided with measurement-use points.

The acquisition unit 22 has a function of acquiring information relating to a fish detected as a measurement target in the captured images 41A and 41B, the information being used in identification processing performed by the identification unit 23. In the first example embodiment, the acquisition unit 22 acquires three types of information as follows.

One type of information that the acquisition unit 22 acquires is information of inclination θ of a detected fish body 60 as illustrated in FIG. 7. In the first example embodiment, a line parallel with the horizontal lines of the rectangular captured images 41A and 41B is defined as a baseline Sg of the captured images 41A and 41B. A line connecting the mouth and a bifurcating portion of the tail detected by the detection unit 21 on the detected fish body 60 is defined as a baseline Sk of the detected fish body 60. Further, an angle between the baselines Sg and Sk is acquired as the inclination θ of the detected fish body 60.

Another type of information that the acquisition unit 22 acquires is information related to size of the detected fish body 60 in the captured images 41A and 41B. In the first example embodiment, information of horizontal length W and vertical length H of the rectangular fish body detection region Z as illustrated in FIG. 6 detected by the detection unit 21 is acquired by the acquisition unit 22 as information related to the size of the detected fish body 60. The horizontal length W and the vertical length H of the fish body detection region Z are data using a pixel, which is a minimum unit constituting the captured images 41A and 41B, as a unit. The unit used in expressing the horizontal length W and the vertical length H of the fish body detection region Z is not limited to a pixel and may be an appropriately set unit or a unit based on the metric system.

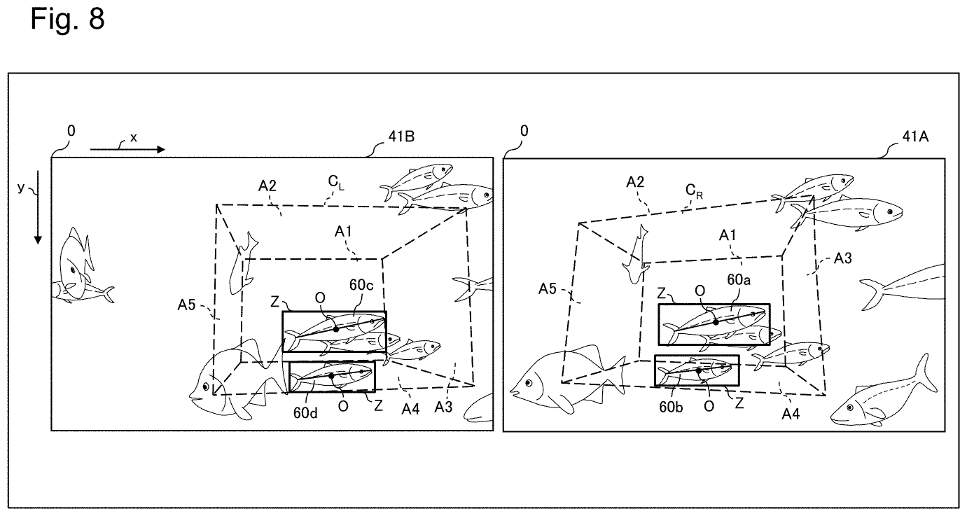

Still another type of information that the acquisition unit 22 acquires is information related to an arrangement position of the detected fish body 60 in the captured images 41A and 41B. In the first example embodiment, to the storage device 30, information of measurement areas C_{L} and C_{R} as illustrated in FIG. 8 in the captured images 41A and 41B is provided. The measurement areas C_{L} and C_{R} are areas in which spatial areas that served as targets of calibration when the cameras 40A and 40B were calibrated are imaged and are areas in which information containing a large amount of error due to distortion of lenses or the like has been corrected and from which information of length and the like the reliability of which has been increased can be acquired. The measurement areas C_{L} and C_{R} are divided into a plurality of sub-areas. In the example in FIG. 8, each of the measurement areas C_{L} and C_{R} is divided into five divided areas A1, A2, A3, A4, and A5.

The acquisition unit 22 acquires information of coordinates in the captured images 41A and 41B representing a center position O of each fish body 60 detected by the detection unit 21. For example, the center position O of a fish body 60 is defined as the middle position of a line segment connecting a bifurcating portion of the tail and the mouth of the fish body 60 detected by the detection unit 21 (see FIG. 8). Coordinates representing a position in each of the captured images 41A and 41B is assumed to be represented by a two-dimensional Cartesian coordinate system with the upper left corner in FIG. 8 defined as the origin, the abscissa as the x-axis, and the ordinate as the y-axis. Herein, a pixel is used as a unit.

The acquisition unit 22 compares the acquired coordinates of the center position O of each fish body 60 with the display positions of the divided areas A1 to A5 and acquires information representing in which one of the divided areas A1 to A5 the center position O is arranged as information related to the arrangement position of the detected fish body 60.

The identification unit 23 has a function of specifying the same detected fish bodies 60 in the captured image 41A and the captured image 41B and associating the specified detected fish body 60 in the captured image 41A with the specified detected fish body 60 in the captured image 41B. In the first example embodiment, the identification unit 23 specifies, by use of the information acquired by the acquisition unit 22, the same detected fish bodies 60 in the captured images 41A and 41B.

That is, in the first example embodiment, the identification unit 23 compares inclinations θ between a detected fish body 60 in the captured image 41A and a detected fish body 60 in the captured image 41B and, when a difference between the inclinations θ falls within a preset allowable range, determines that the inclinations are similar to each other.

The identification unit 23 compares pieces of information relating to size between a detected fish body 60 in the captured image 41A and a detected fish body 60 in the captured image 41B and determines whether the sizes of the detected fish bodies 60 in the captured images 41A and 41B are similar to each other. For example, the identification unit 23 uses the sizes of fish body detection regions Z detected by the detection unit 21 as pieces of information of size of the detected fish bodies 60. Although the identification unit 23 may compare the sizes (for example, one or more of vertical length H, horizontal length W, and area M (M=W×H)) of fish body detection regions Z in the captured images 41A and 41B with each other, the identification unit 23 may determine whether the sizes of the fish body detection regions Z are similar to each other in the following manner. It is assumed herein that sizes being similar to each other indicates that the sizes are the same as each other or that a difference between the compared sizes falls within a preset allowable range.

For example, the identification unit 23 determines whether the sizes of fish body detection regions Z in the captured images 41A and 41B are similar to each other by determining whether a calculated value Score that is calculated in accordance with the formula (1) below falls within a preset allowable range (see the formula (2)).

$$\begin{matrix}Score = \frac{{W}_{R}}{{W}_{L}} + \frac{{H}_{R}}{{H}_{L}} & ( 1 ) \\ α < Score < β & ( 2 )\end{matrix}$$

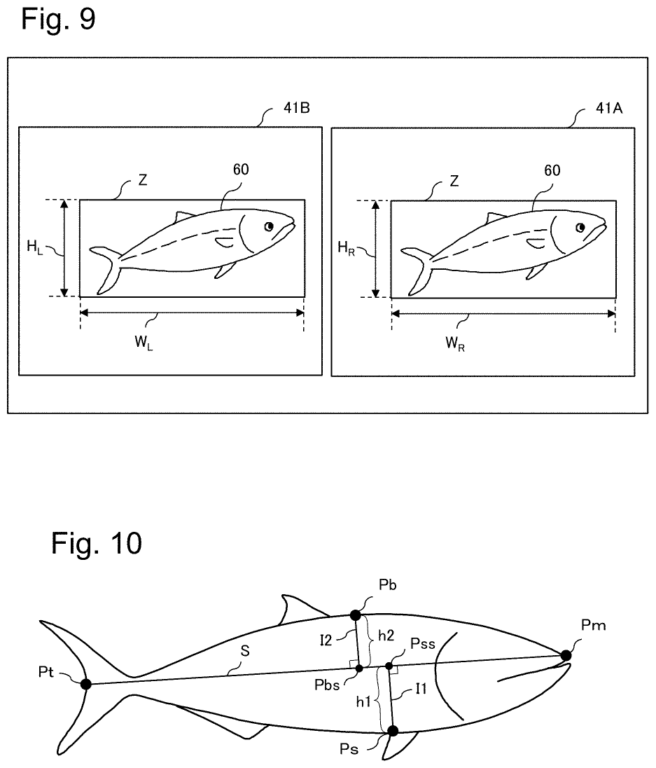

In the above formula (1), W_{R} denotes the horizontal length of a fish body detection region Z to be compared in the captured image 41A, as illustrated in FIG. 9. Similarly, W_{L} denotes the horizontal length of a fish body detection region Z to be compared in the captured image 41B. In addition, H_{R} denotes the vertical length of the fish body detection region Z to be compared in the captured image 41A. Similarly, H_{L} denotes the vertical length of the fish body detection region Z to be compared in the captured image 41B.

In the above formula (2), α and β are constants representing an allowable range for a difference between the sizes of fish body detection regions Z to be compared and are determined in advance in consideration of the performance of the cameras 40A and 40B, an image-capturing environment, and the like. For example, α and β are set as α=1.7 and β=2.3.

Further, the identification unit 23 compares pieces of information related to the arrangement positions of detected fish bodies 60 in the captured images 41A and 41B with each other and determines whether the detected fish bodies 60 to be compared are located at similar positions to each other. For example, the identification unit 23 determines whether divided areas among the divided areas A1 to A5 in which the center positions O of the detected fish bodies 60 to be compared acquired by the acquisition unit 22 are located are the same.

The identification unit 23 may perform, in place of the processing of comparing the arrangement areas of detected fish bodies 60 as described above, comparison of arrangement positions between the detected fish bodies 60 to be compared as follows. For example, the identification unit 23 determines whether calculated values Score_x and Score_y that are calculated in accordance with the formulae (3) and (4) below fall within preset allowable ranges (see the formulae (5) and (6)). Based on this determination, the identification unit 23 determines whether the arrangement positions of the detected fish bodies 60 in the captured images 41A and 41B are similar to each other.

Score_x=x_{cl}−x_{cr} (3)

Score_y=y_{cl}−y_{cr} (4)

γ_x<Score_x<δ_x (5)

γ_y<Score_y<δ_y (6)

In the above formula (3), x_{cr} denotes the x-coordinate of the center position O of the fish body 60 in the captured image 41A. Similarly, x_{cl} denotes the x-coordinate of the center position O of the fish body 60 in the captured image 41B. In the above formula (4), y_{cr} denotes the y-coordinate of the center position O of the fish body 60 in the captured image 41A. Similarly, y_{cl} denotes the y-coordinate of the center position O of the fish body 60 in the captured image 41B.

In the above formulae (5) and (6), γ_x, δ_x, γ_y, and δ_y are constants representing allowable ranges for a difference between the center positions O of the fish bodies 60 in the captured images 41A and 41B and are determined in advance in consideration of the interval between the cameras 40A and 40B, and the like. For example, γ_x, δ_x, γ_y, and δ_y are set as γ_x=120 px (pixels), δ_x=280 px, γ_y=−50 px, and δ_y=50 px.

In the processing relating to the arrangement positions of detected fish bodies 60, the center positions of fish body detection regions Z may be used in place of use of the center positions O of the fish bodies 60.

The identification unit 23 specifies, based on the inclinations θ of detected fish bodies 60, the sizes of the detected fish bodies 60 (fish body detection regions Z), and the arrangement positions of the detected fish bodies 60 in the captured images 41A and 41B, the same detected fish body 60 in the captured images 41A and 41B. In the first example embodiment, the identification unit 23 determines that a pair of detected fish bodies 60 that are determined to be similar to each other with respect to all three types of information, namely the inclinations θ of the detected fish bodies 60, the sizes of the detected fish bodies 60 (the fish body detection regions Z), and the arrangement positions of the detected fish bodies 60, are the same fish body.

For example, it is assumed that, as illustrated in FIG. 8, fish bodies 60a and 60b are detected in the measurement area C_{R} in the captured image 41A and fish bodies 60c and 60d are detected in the measurement area C_{L} in the captured image 41B. When comparing the fish body 60a in the captured image 41A with the fish body 60d in the captured image 41B, while the inclinations θ of the detected fish bodies 60a and 60d are similar to each other, a difference between the sizes of the fish body detection regions Z falls outside the allowable range. While the divided area in which the center position O of the detected fish body 60a is located is the divided are A1, the divided area in which the center position O of the detected fish body 60d is located is the divided area A4, and the arrangement positions of the detected fish bodies 60a and 60d are thus different from each other. Based on such comparison results, the identification unit 23 determines that the detected fish bodies 60a and 60c are not the same fish body.

On the other hand, since, when comparing the fish body 60a in the captured image 41A with the fish body 60c in the captured image 41B, the detected fish bodies 60a and 60c are similar to each other with respect to the three types of information, namely the inclinations θ of the detected fish bodies 60a and 60c, the sizes of the fish body detection regions Z, and the arrangement positions, the identification unit 23 determines (identifies) the detected fish bodies 60a and 60c to be the same fish body.

The measurement unit 25 has a function of performing predetermined measurement processing, setting, as fish bodies to be measured, detected fish bodies 60 in the captured images 41A and 41B specified (identified) to be the same fish bodies by the identification unit 23. For example, the measurement unit 25 calculates a length (fork length) between a bifurcating portion of the tail and the mouth of a detected fish body 60. That is, the measurement unit 25 acquires, from the storage device 30, information of the display positions of a bifurcating portion of the tail and the mouth that were detected as measurement-use points by the detection unit 21 on a detected fish body 60 that were identified as the same fish body in the captured images 41A and 41B and the interval between the cameras 40A and 40B. The measurement unit 25 calculates, by use of the acquired information, coordinates in, for example, the three-dimensional spatial coordinate system of the measurement-use points (the bifurcating portion of the tail and the mouth of the fish) through a triangulation method. Further, the measurement unit 25 calculates, based on the calculated coordinates, a length (that is, fork length) L between the bifurcating portion of the tail and the mouth of the fish body to be measured. The measurement value of the fork length L calculated in this manner is stored in the storage device 30 in association with, for example, observation date and time, information of the image-capturing environment, such as weather conditions, and the like.

Further, the measurement unit 25 may calculate a body depth of a fish body to be measured. In this case, the detection unit 21 has a function of detecting, as measurement-use points, a top portion on the back side and a bulging portion on the abdomen side (for example, a joint portion of the pelvic fin) on the detected fish body 60. The measurement unit 25 calculates a length of a line segment connecting the top portion on the back side and the bulging portion on the abdomen side, which were detected as measurement-use points, as a body depth H of the fish body to be measured. Alternatively, the measurement unit 25 may calculate the body depth H of a fish body to be measured in the following way.

That is, for example, it is assumed that, as illustrated in FIG. 10, the mouth, a bifurcating portion of the tail, a top portion on the back side, and a bulging portion on the abdomen side of a fish body to be measured that were detected as measurement-use points are denoted by points Pm, Pt, Pb, and Ps, respectively. A line connecting the mouth and the bifurcating portion of the tail that are measurement-use points is defined as a baseline S. Further, it is assumed that an intersection point of a perpendicular drawn down from the top portion Pb on the back side, which is a measurement-use point, to the baseline S and the baseline S is denoted by Pbs and an intersection point of a perpendicular drawn down from the bulging portion Ps on the abdomen side, which is a measurement-use point, to the baseline S and the baseline S is denoted by Pss. The measurement unit 25, by adding the length h1 of a line segment between the bulging portion Ps on the abdomen side and the point Pss and the length h2 of a line segment between the top portion Pb on the back side and the point Pbs, calculates a body depth H (H=h1+h2) of the fish body to be measured.

The measurement value of the body depth H of a fish body calculated in this manner is stored in the storage device 30 in association with, for example, a measurement value of the fork length L of the same fish body and, further, as with the above, in association with, for example, observation date and time, information of the image-capturing environment, such as weather conditions, and the like.

The analysis unit 26 has a function of performing predetermined analysis by use of the fork lengths L and body depths H of a plurality of fishes to be measured and information associated with the information, which are stored in the storage device 30. For example, the analysis unit 26 calculates an average of the fork lengths L of a plurality of fishes in the fish preserve 48 at the observation date. Alternatively, the analysis unit 26 calculates an average of the fork lengths L of a specific fish that is set as an analysis target. In this case, the average of a plurality of fork lengths L of the fish to be analyzed that are calculated from images of the fish to be analyzed in a plurality of frames of a video captured for a short period of time, such as one second, is calculated.

When the average of the fork lengths L of a plurality of fishes in the fish preserve 48 is calculated and the fishes are not individually identified, it is concerned that, as the values of the fork lengths L of fishes that are to be used for the calculation of the average, values of the same fish may be used in a duplicate manner. Note, however, that, when the average of the fork lengths L of a large number of fishes is calculated, adverse effect of using a value in a duplicate manner on the calculation precision of the average becomes small.

The analysis unit 26 may calculate a relationship between the fork lengths L of fishes in the fish preserve 48 and the number of the fishes (fish body number distribution with respect to the fork lengths L of fishes). Further, the analysis unit 26 may calculate temporal change in the fork length L of a fish, which represents growth of the fish in the fish preserve 48.

Further, the analysis unit 26 may also have a function of calculating a weight of a fish to be measured by use of data for weight calculation that are stored in the storage device 30 in advance and the calculated fork length L and body depth H. The data for weight calculation are data for calculating a weight of a fish, based on the fork length L and body depth H of the fish and are, for example, provided in a form of mathematical formula. The data for weight calculation are data generated based on a relationship between the fork length and body depth and the weight that is acquired based on actually measured fork lengths, body depths, and weights of fishes. When the relationship between the fork length and body depth and the weight differs depending on the age in month or age in year of a fish, the data for weight calculation are generated with respect to each age in month or each age in year and stored in the storage device 30. In this case, the analysis unit 26 calculates a weight of the fish to be measured, based on data for weight calculation according to the age in month or age in year of the fish to be measured and the calculated fork length L and body depth H of the fish to be measured.

The weight of the fish to be measured, which is calculated by the analysis unit 26, and the fork length L and body depth H of the fish to be measured, which are calculated by the measurement unit 25, are stored in the storage device 30 in association with each other and also in association with predetermined information (for example, image-capturing date and time). The display control unit 24 may have a function of, when, for example, the observer inputs, by use of the input device 11, an instruction to make the display device 12 display the measured values, receiving the instruction, reading information to be displayed from the storage device 30, and displaying the information on the display device 12.

The information processing device 10 of the first example embodiment is, due to having the functions as described above, capable of achieving the following advantageous effects. That is, the information processing device 10 performs identification processing of determining whether detected fish bodies 60 each of which is detected in one of a plurality of captured images that are captured by the cameras 40A and 40B arranged side by side with an interval interposed therebetween are the same fish body. In the identification processing, the inclinations θ of the baselines Sk of the detected fish bodies 60 from the baselines Sg of the captured images 41A and 41B, information related to the sizes of the detected fish bodies 60 in the captured images 41A and 41B, and information relating to the arrangement positions of the detected fish bodies 60 in the captured images 41A and 41B are used. Using such information enables the information processing device 10 to increase reliability of determination results from the identification processing of fish bodies.

The information processing device 10 of the first example embodiment uses, as the information related to the sizes of detected fish bodies 60, the sizes of rectangular fish body detection regions Z. Processing of calculating a size of a rectangular fish body detection region Z is simpler than processing of calculating a size of a fish body, based on the complex silhouette of the fish body. This configuration enables the information processing device 10 to reduce time required for the processing using the information of the sizes of detected fish bodies 60. As described above, since the information processing device 10, while simplifying processing and thereby reducing processing time, determines whether detected fish bodies 60 are the same fish body by use of a plurality of types of information in the identification processing, the information processing device 10 is capable of increasing reliability of determination results.

Further, because of being capable of increasing accuracy of processing of specifying the same fish body in the captured images 41A and 41B, the information processing device 10 is capable of increasing reliability of information in the depth direction calculated from the captured images 41A and 41B. This capability enables the information processing device 10 to increase reliability of measurement values and analysis results of the fork length and body depth of a fish body 60 to be calculated.

### Other Example Embodiments

The present invention may, without being limited to the first example embodiment, employ various example embodiments. For example, although, in the first example embodiment, the information processing device 10 includes the analysis unit 26, the processing of analyzing a result of measurement processing performed by the measurement unit 25 with respect to a detected fish body 60 identified by the identification unit 23 may be performed by an information processing device separate from the information processing device 10. In this case, the analysis unit 26 is omitted.

In the first example embodiment, the information processing device 10 may perform image processing to reduce turbidity of water in captured images and image processing to correct distortion of fish bodies in captured images due to trembling of water at an appropriate timing, such as a point of time before the start of detection processing performed by the detection unit 21. The information processing device 10 may perform image processing to correct captured images in consideration of image-capturing conditions, such as depth in the water at which fishes are present and the brightness of water. As described above, the information processing device 10 performing image processing (image correction) on captured images in consideration of an image-capturing environment enables reliability for detection processing performed by the detection unit 21 to be increased.

Further, although, in the first example embodiment, description is made using fishes as an example of an object to be detected, the information processing device 10 having the constitution described in the first example embodiment is applicable to detection of other objects. In particular, the information processing device 10 having the constitution described in the first example embodiment is capable of, in the case where an object to be measured is not an immobile object but a mobile object, exhibiting the capability of identification processing of the object.

Further, in the first example embodiment, information that the identification unit 23 uses for the identification processing is three types of information, namely information of the inclinations θ of detected fish bodies 60, information of the sizes of the detected fish bodies 60 (fish body detection regions Z), and information of the arrangement positions of the detected fish bodies 60 (fish body detection regions Z). In place of the above configuration, information that the identification unit 23 uses for the identification processing may be a type of information or two types of information among the above-described three types of information in consideration of a movement situation of objects to be detected, density of objects in captured images, object shapes, an environment around objects, and the like.

Further, although, in the first example embodiment, a fish body detection region Z is a rectangular shape, the shape of the fish body detection region Z is not limited to a rectangular shape and may be, for example, another shape, such as an ellipse, determined in consideration of the shape of an object to be detected. Note, however, that, when the shape of a fish body detection region Z is a simple shape, such as a rectangle and an ellipse, processing of calculating the size of the fish body detection region Z as information of the size of a detected fish body 60 and processing of specifying the center position of the fish body detection region Z as information of the arrangement position of the detected fish body 60 become easier.

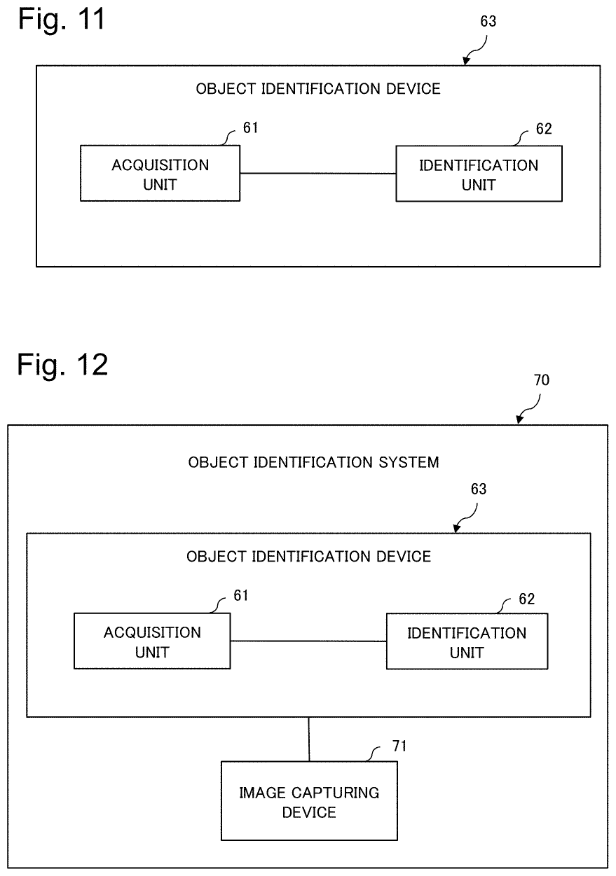

Further, in FIG. 11, a constitution of an object identification device of another example embodiment according to the present invention is illustrated in a simplified manner. An object identification device 63 in FIG. 11 includes, as functional units, an acquisition unit 61 and an identification unit 62. The acquisition unit 61 has a function of acquiring at least a type of information among the following three types of information with respect to objects each of which is detected in one of a plurality of captured images that are captured from positions located side by side with an interval interposed between the positions. One type of information is information of the inclinations of baselines of the objects with respect to baselines of the captured images. Another type of information is information related to the sizes of the objects in the captured images. Still another type of information is information related to the arrangement positions of the objects in the captured images.

The identification unit 62 has a function of comparing pieces of information each of which is acquired from one of the captured images by the acquisition unit 61 and determining that objects in the captured images with compared pieces of information the difference between which falls within a preset allowable range are the same object.

The object identification device 63 is, by having the functions as described above, capable of increasing reliability of processing of specifying, with respect to objects detected in a plurality of captured images, the same object from the plurality of captured images. The object identification device 63 can constitute an object identification system 70 in conjunction with an image capturing device 71, as illustrated in FIG. 12.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-043237, filed on Mar. 9, 2018, the disclosure of which is incorporated herein in its entirety by reference.

### REFERENCE SIGNS LIST

10 Information processing device
22, 61 Acquisition unit
23, 62 Identification unit
21 Detection unit

What is claimed is:

1. An object identification device comprising:
at least one processor configured to:
acquire, with respect to objects each of which is detected in one of a plurality of captured images that are captured from positions located side by side with an interval interposed between the positions, at least one piece of information among information on an inclination of a baseline of the object with respect to a baseline of the captured image, information related to a size of the object in the captured image, and information related to an arrangement position of the object in the captured image; and
compare pieces of information each of which is acquired from one of the captured images and determine that the objects in the captured images a difference of which in compared pieces of information falls within a preset allowable range are a same object.

2. The object identification device according to claim 1, wherein
the at least one processor is further configured to: detect an object to be detected from the captured image by use of reference data of the object;
specify, in the captured image, a detection region with a preset shape, the detection region containing the detected object and having a size according to a size of the object; and
acquire information on a size of the detection region as the information related to the size of the object.

3. The object identification device according to claim 1, wherein,
in each of the captured images, an image area in which a same preset spatial area is imaged is divided into a plurality of divided areas, and
the at least one processor acquires information identifying the divided area in which the detected object is located, as the information related to the arrangement position of the object.

4. The object identification device according to claim 1, wherein
the captured images that serve as bases for pieces of information that the at least one processor compares are images that are captured at a same time.

5. An object identification system comprising:
an image capturing device that captures an image of an object to be detected from positions located side by side with an interval interposed between the positions; and
the object identification device according to claim 1.

6. An object identification method comprising:
by at least one processor,
acquiring, with respect to objects each of which is detected in one of a plurality of captured images that are captured from positions located side by side with an interval interposed between the positions, at least one piece of information among information on an inclination of a baseline of the object with respect to a baseline of the captured image, information related to a size of the object in the captured image, and information related to an arrangement position of the object in the captured image;
comparing pieces of information each of which is acquired from one of the captured images; and
determining that the objects in the captured images a difference of which in compared pieces of information falls within a preset allowable range are a same object.

7. A non-transitory program recording medium recording a computer program causing a computer to perform:
acquiring, with respect to objects each of which is detected in one of a plurality of captured images that are captured from positions located side by side with an interval interposed between the positions, at least one piece of information among information on an inclination of a baseline of the object with respect to a baseline of the captured image, information related to a size of the object in the captured image, and information related to an arrangement position of the object in the captured image;
comparing pieces of information each of which is acquired from one of the captured images; and
determining that the objects in the captured images a difference of which in compared pieces of information falls within a preset allowable range are a same object.
